(19) United States
(12) Patent Application Publication
(10) Pub. No.: US 2025/0118729 A1
(43) Pub. Date: Apr. 10, 2025

(54) LITHIUM-ION BATTERY ELECTRODE PLATE AND PREPARATION METHOD THEREFOR

(71) Applicant: HUIZHOU LIWINON NEW ENERGY TECHNOLOGY CO., LTD, Huizhou (CN)

(72) Inventors: Xu HUANG, Huizhou (CN); Xiaoliang WEI, Huizhou (CN); Yuangao TAN, Huizhou (CN)

(21) Appl. No.: 18/983,459

(22) Filed: Dec. 17, 2024

Related U.S. Application Data
(63) Continuation of application No. PCT/CN2023/101101, filed on Jun. 19, 2023.

(30) Foreign Application Priority Data
Jun. 23, 2022 (CN) 202210716351.7

(51) Int. Cl. H01M 10/052; H01M 4/02; H01M 4/04; H01M 4/133; H01M 4/583; H01M 4/62

(52) U.S. Cl. CPC H01M 10/052; H01M 4/0419; H01M 4/133; H01M 4/583; H01M 4/622; H01M 2004/027; H01M 2200/106

(57) ABSTRACT

The present invention belongs to the technical field of batteries, and specifically relates to a lithium-ion battery electrode plate. The lithium-ion battery electrode plate comprises: a current collector; an active substance layer, which is coated onto the surface of the current collector; a safety coating, which is coated onto the surface of the active substance layer, wherein the safety coating has a thickness of 1-10 μm, and comprises polyolefin latex particles, a cross-linking agent and a binder. In the present invention, by optimizing the structure of the electrode plate, the probability of internal short circuit of a battery can be reduced, such that the safety performance of the battery is improved. Furthermore, the present invention also discloses a preparation method for the lithium-ion battery electrode plate.

### TECHNICAL FIELD

The present invention belongs to the technical field of batteries, and specifically relates to a lithium-ion battery electrode plate and a preparation method therefor.

### BACKGROUND

With increasingly extensive use of lithium-ion batteries in mobile phones, laptops, electric vehicles, power tools, and the like, energy density of the lithium-ion batteries is also rising. Therefore, abuse of the lithium-ion batteries will lead to terrible consequences, and the safety of the batteries receives great attention from people. Abuse tests of the lithium-ion batteries usually include mechanical abuse, thermal abuse, and electrical abuse. Generally speaking, mechanical abuse refers to the deformation of a battery or a battery pack due to external mechanical action, which can lead to fire and explosion. In a laboratory, nail penetration, unilateral crush and the like are usually performed to test the mechanical abuse performance of battery. During the test, a separator inside the battery ruptures, resulting in an internal short circuit due to direct contact between a positive electrode plate and a negative electrode plate. Therefore, a large amount of energy is released in a very short period of time, a heating rate of the battery is much faster than a rate of heat dissipation, and thermal runaway occurs after a critical temperature is reached. In the thermal abuse test of the battery, as heat accumulates inside the battery, a temperature of the battery will rise continuously. When reaching its melting point, the separator starts to melt, leading to a short circuit between the anode and the cathode, releasing more heat and inevitably causing thermal runaway. In other abuse tests, such as overcharging, there is a risk that precipitated lithium dendrites will pierce the separator, thus resulting in the thermal runaway of the battery. The essence of battery abuse is the occurrence of internal short circuit under the action of various factors, ultimately resulting in thermal runaway of the battery.

Existing methods for improving the battery abuse performance include using a positive temperature coefficient (PTC) thermistor. When the temperature of the battery reaches a Curie temperature of a PTC element, resistance of the battery increases rapidly, thereby cutting off a circuit and preventing further thermal runaway. However, the methods also have deficiencies. Specifically, due to the limitations of heat transfer rate, the PTC element suffers a time lag in response to the temperature. When it takes effect, the temperature inside the battery is often higher than its Curie point, and when the thermal runaway occurs, the time delay may cause serious consequences. In addition, a method of ceramic coating on a surface of the separator can be used, but the method is costly and has a risk of ceramic shedding during battery cycling.

### SUMMARY

In order to solve the defects in the prior art, a first objective of the present invention is to provide a lithium-ion battery electrode plate, and the probability of internal short circuit of a battery can be reduced by optimizing a structure of the electrode plate, such that the safety performance of the battery is improved.

In order to achieve the above objective, the present invention adopts the following technical solution:
a lithium-ion battery electrode plate, including a current collector; an active substance layer, which is coated onto a surface of the current collector; a safety coating, which is coated onto a surface of the active substance layer, where the safety coating has a thickness of 1-10 μm, and includes polyolefin latex particles, a cross-linking agent and a binder.

Preferably, the polyolefin latex particles are 100 parts by mass, the cross-linking agent is 0.05-2 parts by mass, and the binder is 10-20 parts by mass.

Preferably, the polyolefin latex particles are polyethylene, polypropylene, and ethylene-propylene graft and block copolymers.

Preferably, the cross-linking agent is epoxy-based glycidyl ether, melamine-based hexakis(methoxymethyl)melamine, and isocyanate-based toluene diisocyanate.

Preferably, the binder is styrene-butadiene rubber (SBR), polyvinylidene fluoride, polytetrafluoroethylene or polyacrylic acid polymer material.

Preferably, the active substance layer includes active material of negative electrode, a conductive agent and an adhesive; the active material of negative electrode is at least one of graphite, lithium titanate and silicon-based negative electrode material, the conductive agent is at lease of conductive carbon black, carbon nanotubes, and graphene, and the adhesive is styrene-butadiene rubber.

Preferably, the graphite is a layered structure, and the lithium titanate is spinel-type.

Preferably, the safety coating is coated onto the surface of the active substance layer by gravure printing or spraying.

Preferably, the safety coating has the thickness of 3-5 μm.

A second objective of the present invention is to provide a preparation method for the lithium-ion battery electrode plate, including the following steps:
step 1. mixing polyolefin latex particles, a cross-linking agent and a binder in a preset ratio to obtain slurry of safety coating;
step 2. coating slurry of an active substance layer of negative electrode onto a surface of a current collector and then drying at 80° C.; and
step 3. coating the slurry of safety coating onto a surface of the active substance layer of negative electrode and drying for rolling and slitting to obtain the negative electrode plate.

The present invention has the beneficial effects: the safety coating is coated onto the surface of the active substance layer. Under normal operating conditions of the battery, there are gaps between the polyolefin latex particles 4 coated on the surface of the active substance layer 2, which can conduct lithium ions, without affecting the normal operation of the battery. When the battery is abused and a temperature of the battery reaches a preset threshold, the polyolefin latex particles 4 melt, and the cross-linking agent 5 decomposes to produce free radicals, which triggers the crosslinking of the polyolefin latex particles 4 to form a dense membrane capable of blocking the transport of lithium ions, that is, forming an insulating layer capable of cutting off short-circuit current and preventing thermal runaway of the battery. The presence of the safety coating is conducive to reducing the probability of direct contact between positive current collector aluminum foil and negative active material, provides dual protective effects with the separator, and reduces the probability of internal short circuit of the battery, such that the safety performance of the battery is improved.

### BRIEF DESCRIPTION OF THE DRAWINGS

The features, advantages and technical effects of exemplary embodiments of the present invention will be described below with reference to the accompanying drawings.

FIG. 1 is a schematic diagram of a safety coating containing polyolefin latex particles according to the present invention.

FIG. 2 is a schematic diagram of a safety coating that undergoes crosslinking with a cross-linking agent under the action of high temperatures according to the present invention.

Reference numerals in the accompanying drawings:
1—current collector;
2—active substance layer;
3—safety coating;
4—polyolefin latex particles; and
5—cross-linking agent

### DETAILED DESCRIPTIONS OF THE EMBODIMENTS

When some terms are used in the specification and claims to refer to specific components, those skilled in the art should understand that hardware manufacturers may use different terms to refer to a same component. The specification and claims do not distinguish components based on differences in name, but based on differences in functions of the component. The term “include/including/comprise/comprising” used in the specification and claims should be taken as an open-ended term and interpreted as “including but not limited to”. The term “roughly” means that it falls within an acceptable error range, and those skilled in the art can solve the technical problems within a certain error range and basically achieve the intended technical effects.

In addition, the terms “first”, “second” and the like are for descriptive purposes only and should not be construed as indicating or implying relative importance.

It should be noted that, unless otherwise explicitly specified and defined, the terms “mounting”, “connecting”, “connection” and “fixed” in the present invention should be understood in a broad sense, for example, they may be a fixed connection, a detachable connection, or an integrated connection; may be a mechanical connection, or an electrical connection; and may be a direct connection, or an indirect connection via an intermediate medium, or communication inside two elements. Those of ordinary skill in the art can understand specific meanings of the above terms in the present invention according to specific circumstances.

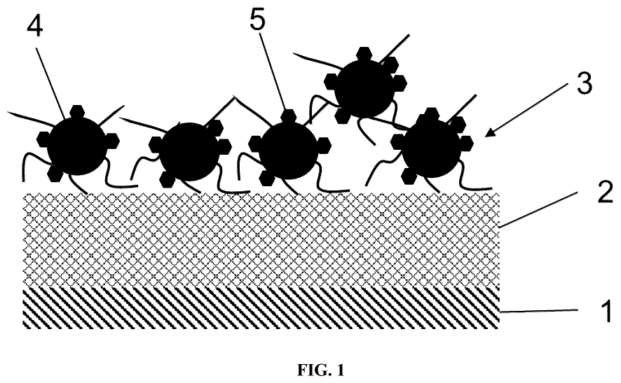

The present invention will be further described in detail below in conjunction with FIG. 1, which, however, are not taken as a basis for limiting the present invention.
a lithium-ion battery electrode plate, including:
a current collector 1, an active substance layer 2 coated onto a surface of the current collector 1, and a safety coating 3 coated onto a surface of the active substance layer 2, where the safety coating 3 has a thickness of 1-10 μm, and includes polyolefin latex particles 4, a cross-linking agent 5 and a binder.

Due to the limitations of heat transfer rate, a PTC element suffers a time lag in response to a temperature. When it takes effect, the temperature inside the battery is usually higher than its Curie point, and when the thermal runaway occurs, the time delay may cause very serious consequences. In addition, a method of ceramic coating on a surface of separator can be used, but the method is costly and has a risk of the ceramic shedding during battery cycling. Therefore, abuse performance of the battery can be improved by coating the surface of the active substance layer 2 with the safety coating 3. Under normal operating conditions of the battery, there are gaps between the polyolefin latex particles 4 coated on the surface of the active substance layer 2, which can conduct lithium ions, without affecting the normal operation of the battery. When the battery is abused and a temperature of the battery reaches a preset threshold, the polyolefin latex particles 4 melt, and the cross-linking agent 5 decomposes to produce free radicals, which triggers the crosslinking of the polyolefin latex particles 4 to form a dense membrane capable of blocking the transport of lithium ions, that is, forming an insulating layer capable of cutting off short-circuit current and preventing thermal runaway of the battery. The presence of the safety coating is conducive to reducing the probability of direct contact between positive current collector aluminum foil and negative active material, provides dual protective effects with the separator, and reduces the probability of internal short circuit of the battery, such that the safety performance of the battery is improved.

When the battery is abused, the crosslinking of the polyolefin latex particles 4 in the safety coating forms the dense membrane capable of blocking the transport of lithium ions, such that the lithium-ion battery can pass through abuse tests such as nail penetration, unilateral crush, foreign object crush, thermal chamber, and overcharging, which is conducive to improving battery quality; and preferably the safety coating 3 has the thickness of 3-5 μm. In addition, the polyolefin latex particles 4 can expand at lower temperatures, such that gaps between them are reduced and a PTC effect is produced. When the temperature further rises and reaches the preset threshold, functional groups on surfaces of the polyolefin latex particles can be cross-linked under the action of an initiator to an insulating membrane capable of blocking the current.

In a lithium-ion battery electrode plate according to the present invention, the polyolefin latex particles 4 are 100 parts by mass, the cross-linking agent 5 is 0.05-2 parts by mass, and the binder is 10-20 parts by mass. The parts by mass of the cross-linking agent 5 are limited to prevent the cross-linking agent 5 from being too low, which could result in a decrease in the sensitivity of the safety coating 3 to temperature response, and result in insufficient crosslinking of a polymer matrix, such that the safety coating 3 cannot block contact between the positive current collector and the negative active material. When the cross-linking agent 5 has a very high content, unreacted cross-linking agent 5 could exist after sufficient crosslinking of the polymer matrix, resulting in an increase in production costs.

In a lithium-ion battery electrode plate according to the present invention, the polyolefin latex particles 4 are polyethylene, polypropylene, and ethylene-propylene graft and block copolymers. Specifically, the polyolefin latex particles 4 are aqueous polyolefin latexes, and are polyethylene (PE), polypropylene (PP), and ethylene-propylene graft and block copolymers that have been modified with organic acids (such as maleic acid, p-Phthalic acid, hexanedioic acid, and fumaric acid) or acid anhydrides thereof with a functionality of not lower than 2. Considering the production costs, the organic acid is preferably the maleic acid or acid anhydride thereof.

In a lithium-ion battery electrode plate according to the present invention, the cross-linking agent 5 can be an organic small molecule with a functionality of not lower than 2, and preferably epoxy-based glycidyl ether, melamine-based hexakis(methoxymethyl)melamine, isocyanate-based toluene diisocyanate, and the like; and the cross-linking agent 5 decomposes at a temperature of higher than 80° C. to generate free radicals, which trigger the crosslinking of the polyolefin latex particles 4.

In a lithium-ion battery electrode plate according to the present invention, the binder is styrene-butadiene rubber (SBR), polyvinylidene fluoride, polytetrafluoroethylene or polyacrylic acid polymer material, and preferably water-based binder of the styrene-butadiene rubber.

In a lithium-ion battery electrode plate according to the present invention, the safety coating 3 is coated onto the surface of the active substance layer 2 by gravure printing or spraying. The gravure printing or spraying offers high precision and good stability, and can generate a coating with a smaller surface density and a thinner coating layer, therefore, slurry of the safety coating 3 is coated onto the surface of the active substance layer 2 of the negative electrode plate by the gravure printing or spraying.

The active substance layer of negative electrode material mainly includes active material of negative electrode, a conductive agent and an adhesive; and the active material of negative electrode is one or more of layered graphite, spinel-type lithium titanate, and high-capacity silicon-based negative electrode material, the conductive agent mainly includes one or more of conductive carbon black, carbon nanotubes, and graphene, and the adhesive is styrene-butadiene rubber (SBR).

### Example 1

### (1) Preparing Safety Coating Slurry of Negative Electrode:

Maleic acid anhydride-modified polyolefin latex particles, styrene-butadiene rubber as a binder, and glycidyl ether as a cross-linking agent were mixed in a weight ratio of 100:15:0.1 to obtain the safety coating slurry.

### (2) Preparing a Negative Electrode Plate:

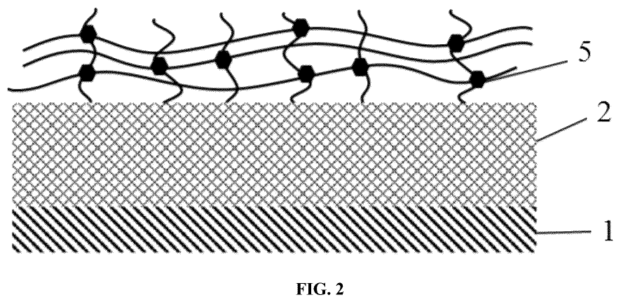

Graphite, a thickener, and styrene-butadiene rubber as a binder were mixed evenly in a mass ratio of 97.7:1.1:1.2 to form a lithium-ion battery negative electrode slurry with a preset viscosity; the slurry was coated onto one surface of a copper current collector, which was dried and rolled at 80° C.; the negative electrode slurry was then coated on the other surface of the copper current collector and dried to obtain a negative electrode plate with active material coated onto both surfaces thereof; the safety coating slurry was coated onto a surface of an active substance layer of the negative electrode plate by gravure printing or spraying, with a coating thickness of 3 μm; and after the negative electrode plate was dried, the negative electrode plate was rolled and slit into obtain the negative electrode plate with a safety coating 3 on the surface of the active substance layer; and
as shown in FIG. 1, cross-linkage functional groups are introduced into the polyethylene microspheres coated onto the surface of the active substance layer 2; and as shown in FIG. 2, crosslinking can be initiated by the cross-linking agent 5 under a high temperature to form a dense membrane.

### (3) Preparing of a Positive Electrode Plate:

Positive electrode active material, superconducting carbon and carbon nanotubes as a conductive agent and polyvinylidene fluoride as an adhesive were mixed in a mass ratio of 97.6:0.6:0.5:1.3 to form a positive electrode slurry; the positive electrode slurry was coated onto one surface of an aluminum current collector, which was dried and rolled at 85° C.; the positive electrode slurry was then coated on the other surface of the aluminum current collector and dried to obtain a positive electrode plate with active material coated onto both surfaces thereof; and the positive electrode plate was trimming, cutting and slitting to obtain a lithium-ion battery positive electrode plate.

### (4) Preparing Electrolyte:

Lithium hexafluorophosphate (LiPF₆) was dissolved in a mixed solvent of dimethyl carbonate (DMC), ethylene carbonate (EC), and ethyl methyl carbonate (EMC) in a mass ratio of 3:5:2 to obtain the electrolyte.

### (5) Preparing a Battery:

The above positive electrode plate, the negative electrode plate with the safety coating 3, and a separator were wound into a battery cell, where the separator was positioned between adjacent positive electrode plate and negative electrode plate, the positive electrode was connected with an aluminum tab by spot welding, and the negative electrode was connected with a copper tab by spot welding; and the battery cell was then placed in an aluminum-plastic pouch, which was backed, the prepared electrolyte was injected, and sealing, formation and capacity grading were performed to prepare the polymer lithium-ion battery with a capacity of about 5 Ah.

### Example 2

This example differs from Example 1 in that the ratio of glycidyl ether, as a crosslinking agent, in the safety coating 3 is 0.05 parts.

The other methods are the same as those in in Example 1, and will not be repeated here.

### Comparative Example 1

This example differs from Example 1 in that the surface of the active substance layer of negative electrode does not contain a safety coating 3.

The other methods are the same as those in in Example 1, and will not be repeated here.

### Comparative Example 2

This example differs from Example 1 in that the safety coating slurry of negative electrode is made of 100 parts by mass of ordinary polyethylene microspheres and 15 parts by mass of styrene-butadiene rubber, without containing a crosslinking agent 5, and it can only melt under high temperatures to form a low-strength membrane capable of blocking short-circuit current.

The other methods are the same as those in in Example 1, and will not be repeated here.

TABLE 1
Safety test results of battery cells
in examples and comparative examples

| | | | Comparative | Comparative |
|---|---|---|---|---|
| Items under test | Example 1 | Example 2 | Example 1 | Example 2 |
| Nail penetration | 10/10 Pass | 9/10 Pass | 4/10 Pass | 7/10 Pass |
| Unilateral crush | 10/10 Pass | 7/10 Pass | 1/10 Pass | 6/10 Pass |
| Foreign object | 10/10 Pass | 8/10 Pass | 2/10 Pass | 6/10 Pass |
| crush | | | | |
| 130° C. thermal | 10/10 Pass | 10/10 Pass | 5/10 Pass | 8/10 Pass |
| chamber | | | | |
| Overcharging | 10/10 Pass | 10/10 Pass | 5/10 Pass | 8/10 Pass |

It can be seen from the table above that the battery cells prepared in Examples 1-2 have a higher pass rate in abuse tests such as nail penetration, unilateral crush, foreign object crush, thermal chamber, and overcharging, which are significantly better than those prepared in Comparative Examples 1-2, particularly, the pass rate of all tests in Example 1 is 100%, indicating that the safety coating used in the present invention exhibits excellent safety performance. Based on the above test results, it can be inferred that when the battery is abused, the polyolefin latex particles 4 melt, and the cross-linking agent 5 decomposes to generate free radicals, which triggers the crosslinking of the polyolefin latex particles 4 to form a dense membrane capable of blocking the transport of lithium ions, that is, forming an insulating layer capable of cutting off short-circuit current and preventing thermal runaway of the battery.

According to the disclosure and instruction of the above specification, those skilled in the art can make modifications and variations to the above examples. Therefore, the present invention is not limited to the above specific examples, and any obvious improvement, substitutions or variations made those skilled in the art on the basis of the present invention should fall within the protection scope of the present invention. In addition, although some specific terms are used in the specification, these terms are for convenience of description only and do not constitute any limitation to the present invention.

What is claimed is:

1. A lithium-ion battery electrode plate, comprising:
a current collector;
an active substance layer coated onto a surface of the current collector; and
a safety coating coated onto a surface of the active substance layer, wherein the safety coating has a thickness of 1-10 μm, and comprises polyolefin latex particles, a cross-linking agent and a binder.

2. The lithium-ion battery electrode plate according to claim 1, wherein the polyolefin latex particles are 100 parts by mass, the cross-linking agent is 0.05-2 parts by mass, and the binder is 10-20 parts by mass.

3. The lithium-ion battery electrode plate according to claim 1, wherein the polyolefin latex particles are polyethylene, polypropylene, and ethylene-propylene graft and block copolymers.

4. The lithium-ion battery electrode plate according to claim 1, wherein the cross-linking agent is epoxy-based glycidyl ether, melamine-based hexakis(methoxymethyl)melamine, and isocyanate-based toluene diisocyanate.

5. The lithium-ion battery electrode plate according to claim 1, wherein the binder is styrene-butadiene rubber, polyvinylidene fluoride, polytetrafluoroethylene or polyacrylic acid polymer material.

6. The lithium-ion battery electrode plate according to claim 1, wherein the active substance layer comprises active material of negative electrode, a conductive agent and an adhesive; the active material of negative electrode is at least one of graphite, lithium titanate and silicon-based negative electrode material, the conductive agent is at lease of conductive carbon black, carbon nanotubes, and graphene, and the adhesive is styrene-butadiene rubber.

7. The lithium-ion battery electrode plate according to claim 6, wherein the graphite is a layered structure, and the lithium titanate is spinel-type.

8. The lithium-ion battery electrode plate according to claim 1, wherein the safety coating is coated onto the surface of the active substance layer by gravure printing or spraying.

9. The lithium-ion battery electrode plate according to claim 1, wherein the safety coating has the thickness of 3-5 μm.

10. A preparation method for the lithium-ion battery electrode plate, comprising the following steps:
step 1. mixing polyolefin latex particles, a cross-linking agent and a binder in a preset ratio to obtain slurry of safety coating;
step 2. coating slurry of active substance layer of negative electrode onto a surface of a current collector and then drying at 80° C.; and
step 3. coating the slurry of safety coating onto a surface of the active substance layer of negative electrode and drying for rolling and slitting to obtain a negative electrode plate.
